(19) United States
(12) Patent Application Publication
(10) Pub. No.: US 2023/0377095 A1
(43) Pub. Date: Nov. 23, 2023

(54) ENHANCED IMAGES

(71) Applicants: Hewlett-Packard Development Company, L.P., West Layfayette, TX (US); Purdue Research Foundation

(72) Inventors: Xiaoyu Xiang, West Lafayette, IN (US); Tianqi Guo, San Diego, CA (US); Qian Lin, Palo Alto, CA (US); Jan Philip Allebach, West Lafayette, IN (US)

(73) Assignees: Hewlett-Packard Development Company, L.P., Spring, TX (US); Purdue Research Foundation, West Layfayette, IN (US)

(21) Appl. No.: 18/031,561

(22) PCT Filed: Oct. 16, 2020
(86) PCT No.: PCT/US2020/056116

§ 371 Date: Apr. 12, 2023

(51) Int. Cl. G06T 3/40; G06T 7/11; G06T 7/194

(52) U.S. Cl. CPC G06T 3/4076; G06T 7/11; G06T 7/194; G06T 2207/20081; G06T 2207/30201

(57) ABSTRACT

Examples of methods for image enhancement are described. In some examples, a method includes segmenting an image into an object region and a background region. In some examples, the image has a first resolution. In some examples, the method includes generating, using a first machine learning model, an enhanced object region with a second resolution that is greater than the first resolution. In some examples, the first machine learning model has been trained based on object landmarks. In some examples, the method includes generating, using a second machine learning model, an enhanced background region with a third resolution that is greater than the first resolution. In some examples, the method includes combining the enhanced object region and the enhanced background region to produce an enhanced image.

### BACKGROUND

Electronic technology has advanced to become virtually ubiquitous in society and has been used for many activities in society. For example, electronic devices are used to perform a variety of tasks, including work activities, communication, research, and entertainment. Different varieties of electronic circuitry may be utilized to provide different varieties of electronic technology.

### BRIEF DESCRIPTION OF THE DRAWINGS

FIG. 1 is a flow diagram illustrating an example of a method for image enhancement;

FIG. 2 is a block diagram illustrating examples of functions for image enhancement;

FIG. 3 is a block diagram of an example of an apparatus that may be used in image enhancement;

FIG. 4 is a block diagram illustrating an example of a computer-readable medium for image enhancement; and

FIG. 5 is a block diagram illustrating an example of first machine learning model training.

### DETAILED DESCRIPTION

Devices may be utilized to capture and/or share images (e.g., digital images). For example, devices may be utilized to share images on social media. In some cases, image quality may be degraded due to image compression, downsampling, etc. For instance, in some applications like short message service (SMS) with mobile phones, due to storage capacity and/or transmission bandwidth limits, images and videos may be down-sampled and/or compressed to reduce the amount of data utilized. Compression and/or downsampling may degrade image quality and/or user experience. For example, humans may be more visually sensitive to faces or other objects in an image than other content. Accordingly, image enhancement that provides relatively high fidelity for face identity and attributes, and/or that provides relatively fewer artifacts may be useful.

Some of the techniques described herein may be utilized to reduce compression artifacts and/or to enhance the resolution of images with unknown downsampling and/or compression factors. For instance, given an image that is compressed in size and image quality (by a device, web application, and/or platform, etc., for example), some examples of the techniques described herein may provide an enhanced image with reduced compression artifacts and/or enhanced resolution (e.g., n×original size).

Some examples of the techniques described herein may provide enhanced images with relatively high fidelity and/or high detail in a region or regions (e.g., region of an object, face, text, etc.).

In some cases, it may be useful to increase the quality of the appearance of objects (e.g., faces, vehicles, text, etc.) in an image. In some examples of the techniques described herein, a region or regions that include an object or objects (e.g., faces, vehicles, and/or text, etc.) may be detected. A machine learning model or models (e.g., deep neural networks) may be utilized to enhance (e.g., reconstruct) the region(s) and/or background(s). In some examples, enhanced regions may be combined (e.g., blended) to produce an enhanced image.

Machine learning is a technique where a machine learning model is trained to perform a task or tasks based on a set of examples (e.g., training data). Training a machine learning model may include determining weights corresponding to structures of the machine learning model. Artificial neural networks are a kind of machine learning model that are structured with nodes, layers, and/or connections. Deep learning is a kind of machine learning that utilizes multiple layers. A deep neural network is a neural network that utilizes deep learning.

Examples of neural networks include convolutional neural networks (CNNs) (e.g., basic CNN, deconvolutional neural network, inception module, residual neural network, etc.), generative adversarial networks (GANs), and recurrent neural networks (RNNs). Different depths of a neural network or neural networks may be utilized in accordance with some examples of the techniques described herein.

Some examples of the techniques described herein may utilize a machine learning model or models (e.g., deep learning) to increase image resolution and/or quality. For instance, some techniques may be utilized to generate super-resolution images with increased object (e.g., face) rendering quality.

Throughout the drawings, identical or similar reference numbers may designate similar elements and/or may or may not indicate identical elements. When an element is referred to without a reference number, this may refer to the element generally, and/or may or may not refer to the element in relation to any Figure. The figures may or may not be to scale, and the size of some parts may be exaggerated to more clearly illustrate the example shown. Moreover, the drawings provide examples in accordance with the description; however, the description is not limited to the examples provided in the drawings.

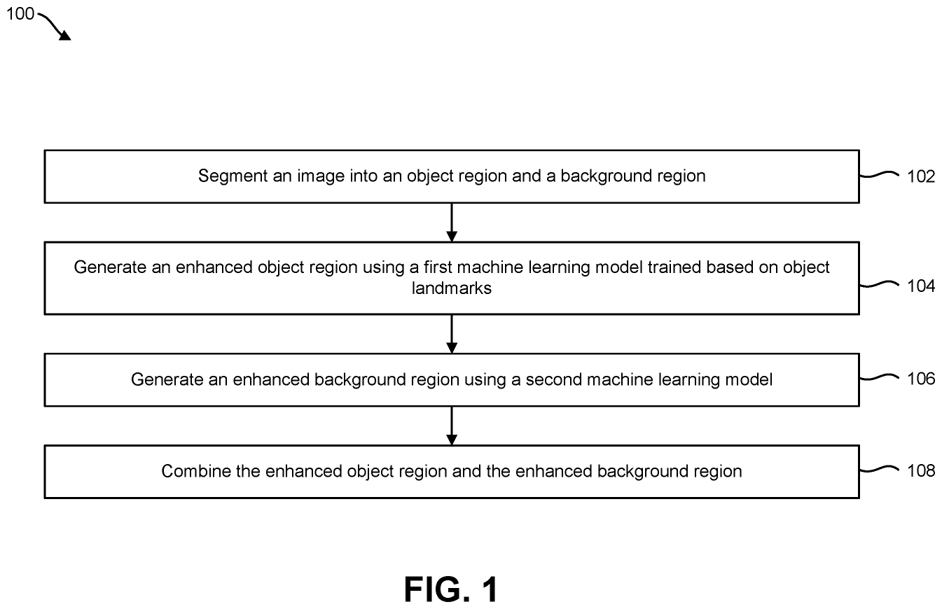

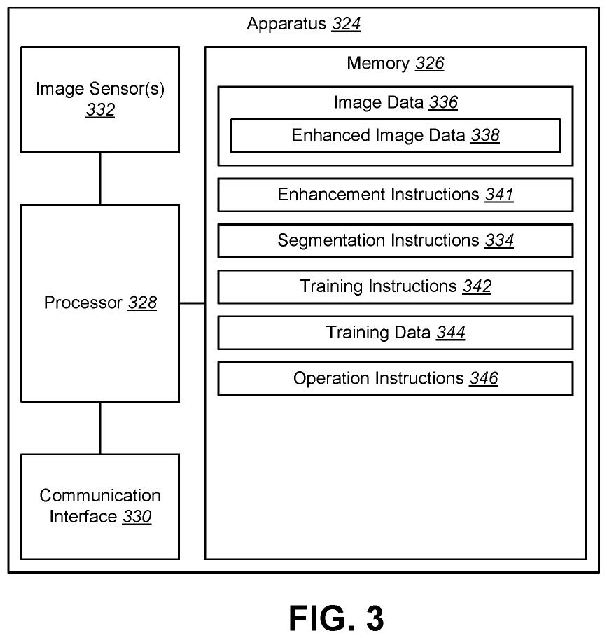

FIG. 1 is a flow diagram illustrating an example of a method 100 for image enhancement. For example, the method 100 may be performed to produce an enhanced image or images. The method 100 and/or an element or elements of the method 100 may be performed by an apparatus (e.g., electronic device, computing device, smartphone, tablet device, laptop computer, server computer, etc.). For example, the method 100 may be performed by the apparatus 324 described in relation to FIG. 3.

The apparatus may segment 102 an image into an object region and a background region, where the image has a first resolution. An image is data that indicates optical information. For instance, an image may be a set of pixel values, an image file, etc. In some examples, an image may have been down-sampled, compressed, and/or may contain artifacts. Resolution is an amount of optical information (e.g., quantity(ies) of pixels) and/or dimensions of optical information (e.g., image height and width in pixels). In some examples, resolution may refer to pixel density. For instance, a higher resolution image may include a relatively greater quantity of pixels, dimensions, and/or pixel density relative to a lower resolution image.

In some examples, segmenting 102 the image into an object region and a background region may include performing object detection. For instance, object detection may be performed to identify a location (e.g., region) of an object or objects in an image. Some examples of object detection may correlate patches of the image with an object template (e.g., face, text, vehicle, other object image) or templates to determine a matching object region or regions (e.g., region(s) of interest (ROI) and/or bounding box(es)) where the object(s) are located in the image. Some examples of object detection may perform pattern recognition (using a machine learning model or models, for instance) to determine an object region or regions (e.g., ROI and/or bounding box(es)) where the object(s) are located in the image.

In some examples, segmenting 102 the image into an object region and a background region may include separating the object region(s) from the background region(s). For instance, the apparatus may separate (e.g., crop, remove, etc.) the object region(s) from the image to produce the background region(s).

The apparatus may generate 104, using a first machine learning model, an enhanced object region with a second resolution that is greater than the first resolution. For example, the object region(s) may be provided to the first machine learning model, which may produce a corresponding enhanced object region or regions.

In some examples, the first machine learning model may be trained based on an object landmark or landmarks. For instance, the first machine learning model is trained or has been trained based on object landmark(s). An object landmark is a structural location or point (e.g., corner, line, edge, vertex, etc.) of an object. For example, object landmarks of a face may include lip corners, nostril edges, nose tip, eye corners, etc. Examples of object landmarks for text may include corners, edges, lines, etc. Examples of object landmarks for vehicles may include edges, corners, hood corners, windshield corners, light (e.g., headlight, taillight, etc.) corners, roof edge, etc.

In some examples, the first machine learning model may be trained based on a landmark loss that is based on an object landmark or landmarks. The landmark loss is a value that indicates a degree of accuracy or inaccuracy of an object landmark or landmarks of an enhanced image produced by the first machine learning model. In some examples, the landmark loss may indicate the distance between landmarks of a ground truth image or images and detected landmarks of an enhanced image from the first machine learning model. In some examples, landmarks of a ground truth image may be provided in metadata of the ground truth image and/or may be extracted using a landmark detector (e.g., object landmark detector, facial landmark detector, etc.).

In some examples, the apparatus or another device may determine landmarks based on an enhanced training image from the first machine learning model and/or may determine second landmarks based on a ground truth image. The landmarks and the second landmarks may be utilized to determine the landmark loss, which may be utilized to train the first machine learning model. For instance, the apparatus or another device may adjust a weight or weights of the first machine learning model (to reduce the landmark loss, for instance).

In some examples, the first machine learning model is trained by the apparatus or another device. For instance, the apparatus may train the first machine learning model, or another device (e.g., computing device, server, etc.) may train the first machine learning model and/or provide the first machine learning model to the apparatus. An aspect or aspects of training the first machine learning model may be performed by the apparatus and/or by another device as follows.

In some examples, the first machine learning model is trained based on determining, using the first machine learning model, an enhanced training image based on a training image. For instance, a training image (e.g., down-sampled, compressed, etc., image) may be provided to the first machine learning model, which may produce an enhanced training image. The first machine learning model may be trained based on determining, using a landmark detection machine learning model, object landmarks based on the enhanced training image. The first machine learning model may be trained based on determining, using the landmark detection machine learning model, second landmarks based on a ground truth image. The first machine learning model may be trained based on determining a landmark loss based on the object landmarks and the second landmarks. For example, the apparatus or another device may utilize a loss function to produce the landmark loss based on the object landmarks and the second landmarks. In some examples, the landmark loss may be denoted lₗₘ=loss(lm_{GT}, lm_{E}), where loss( ) denotes a loss function, lm_{GT} denotes second landmarks (based on a ground truth image, for instance), and lm_{E} denotes object landmarks (based on an enhanced image, for instance). The first machine learning model may be trained based on adjusting weights of the first machine learning model based on (e.g., using) the landmark loss.

In some examples, the first machine learning model may be trained based on an identity feature or features. An identity feature is a value or values (e.g., vector(s)) that relate to an object identity (e.g., object type, object instance, and/or identifying facial characteristics of a person, etc.). In some examples, the first machine learning model may be trained based on determining, using an identity feature extraction machine learning model, first identity features based on an enhanced training image. For example, the identity feature extraction machine learning model may be a machine learning model that is trained to recognize an object (e.g., face, vehicle, text, etc.). In some examples, the identity feature extraction machine learning model may be a facial recognition machine learning model. In some examples, an identity feature may be value(s) representing facial features. For instance, identity features (e.g., facial features) may be produced by providing an affine-aligned face image (e.g., region) to a facial recognition neural network, which may produce the identity features. For example, an identity feature (e.g., facial features) may be a feature vector taken from a facial recognition neural network before a last fully connected layer.

In some examples, the first machine learning model may be trained based on determining, using the identity feature extraction machine learning model, second identity features based on a ground truth image. For instance, a ground truth image may be provided to the identity feature extraction machine learning model, which may produce the second identity features.

In some examples, the first machine learning model may be trained based on determining an identity feature loss based on the first identity features and the second identity features. For example, the apparatus or another device may utilize a loss function to produce the identity feature loss based on the first identity features and the second identity features. Identity feature loss is a value or values that indicates a degree of accuracy or inaccuracy of an identity features of an enhanced image produced by the first machine learning model. For example, identity feature loss may indicate and/or may be a distance between the first identity features (e.g., identity features or facial features from the enhanced training image) and the second identity features (e.g., identity features or facial features from the ground truth image). In some examples, the identity feature loss may be denoted l_{id}=loss(fid_{GT}, fid_{E}), where loss( ) denotes a loss function, fid_{GT} denotes second identity features (based on a ground truth image, for instance), and fid_{E} denotes first identity features (based on an enhanced image, for instance). The first machine learning model may be trained based on adjusting weights of the first machine learning model based on the identity feature loss.

In some examples, the first machine learning model may be trained based on a feature or features. A feature is a value or values (e.g., vector(s)) that relate to an object characteristic or characteristics (e.g., object texture, object color, etc.). In some examples, the first machine learning model may be trained based on determining, using a feature extraction machine learning model, first features based on an enhanced training image. For example, the feature extraction machine learning model may be a machine learning model that is trained to extract features (e.g., texture features, color features, etc.). In some examples, a feature may be value(s) representing texture. For instance, features (e.g., texture features) may be produced by providing an image (e.g., region) to a neural network (e.g., pretrained neural network), which may produce the features. For example, a feature (e.g., texture feature) may be an intermediate feature vector produced by a portion of the neural network.

In some examples, the first machine learning model may be trained based on determining, using the feature extraction machine learning model, second features based on a ground truth image. For instance, a ground truth image may be provided to the feature extraction machine learning model, which may produce the second features.

In some examples, the first machine learning model may be trained based on determining a feature loss based on the first features and the second features. For example, the apparatus or another device may utilize a loss function to produce the feature loss based on the first features and the second features. Feature loss is a value or values that indicates a degree of accuracy or inaccuracy of features of an enhanced image produced by the first machine learning model. For example, feature loss may indicate and/or may be a distance between the first features (e.g., features or texture features from the enhanced training image) and the second features (e.g., features or texture features from the ground truth image). In some examples, the feature loss may be denoted l_{f}=loss(f_{GT}, f_{E}), where loss( ) denotes a loss function, f_{GT} denotes second features (based on a ground truth image, for instance), and f_{E} denotes first features (based on an enhanced image, for instance). The first machine learning model may be trained based on adjusting weights of the first machine learning model based on the feature loss.

In some examples, the first machine learning model may be trained based on a classification or classifications. A classification is a value that indicates a class corresponding to an input. For instance, a classification may indicate whether an input image is generated (e.g., whether the input image has been enhanced) or original (e.g., whether the input image has not been enhanced). In some examples, the first machine learning model may be trained based on classifying, using a discrimination machine learning model, an enhanced training image to produce a first classification. For example, the discrimination machine learning model may be a machine learning model that is trained to predict whether an input image (e.g., enhanced training image or ground truth image) is generated (e.g., enhanced) or original (e.g., not enhanced). In some examples, the discrimination machine learning model may be trained during training of the first machine learning model (e.g., with the first machine learning model). For instance, a classification may be produced by providing an image (e.g., region) to a neural network (e.g., GAN), which may produce the classification. In some examples, the discrimination machine learning model may compare an enhanced training image and a ground truth image and predict whether the enhanced training image and/or the ground truth image are enhanced.

In some examples, the first machine learning model may be trained based on classifying, using the discrimination machine learning model, a ground truth image to produce a second classification. For instance, a ground truth image may be provided to the discrimination machine learning model, which may produce the second classifications.

In some examples, the first machine learning model may be trained based on determining a discrimination loss based on the first classification and the second classification. For example, the apparatus or another device may utilize a loss function to produce the discrimination loss based on the first classification and the second classification. Discrimination loss is a value or values that indicates whether a classification or classifications are accurate. For example, discrimination loss may indicate and/or may be a cross-entropy loss of the classification prediction. In some examples, the discrimination loss may be denoted l_{d}=loss(D_{GT}, D_{E}), where loss( ) denotes a loss function, D_{GT} denotes a second classification (based on a ground truth image, for instance), and D_{E} denotes a first classification (based on an enhanced image, for instance).The first machine learning model may be trained based on adjusting weights of the first machine learning model based on the discrimination loss.

In some examples, the first machine learning model may be trained based on determining a pixel loss between an enhanced training image and a ground truth image. For example, the apparatus or another device may utilize a loss function to produce the pixel loss based on the enhanced training image and the ground truth image. Pixel loss is a value or values that indicates a difference between images. For example, pixel loss may indicate and/or may be a distance between the ground truth image and the enhanced training image. In some examples, the pixel loss may be denoted lₚᵢₓₑₗ=loss(GT, E), where loss( ) denotes a loss function, GT denotes a ground truth image, and E denotes an enhanced image. The first machine learning model may be trained based on adjusting weights of the first machine learning model based on the pixel loss.

In some examples, determining the pixel loss, feature loss, discrimination loss, landmark loss, and/or identity feature loss may be performed using a same loss function or different loss functions. For example, a loss function may determine a Euclidean distance based on input values. For instance, a function that determines Euclidean distance may be one example of a loss function that may be utilized. Other examples of loss functions that may be utilized include L1-loss, Huber loss, Charbonnier loss, etc.

In some examples, the first machine learning model may be trained based on the pixel loss, feature loss, discrimination loss, landmark loss, and/or identity feature loss. For instance, the apparatus or another device may utilize a loss or losses to adjust the weights of the first machine learning model to reduce the loss or losses. In some examples, the apparatus or another device may combine losses (e.g., two, more, or all of the pixel loss, feature loss, discrimination loss, landmark loss, and/or identity feature loss) to determine a combined loss. For example, the first machine learning mode may be trained based on determining a combined loss based on a pixel loss, feature loss, discrimination loss, landmark loss, and/or identity feature loss. In some examples, the combined loss may be determined in accordance with Equation (1).

l_{comb}=λ₁lₚᵢₓₑₗ+λ₂l_{f}+λ₃l_{d}+λ₄lₗₘ+λ₅l_{id} (1)

In Equation (1), l_{comb} is the combined loss, λ₁ is a weight factor for the pixel loss, λ₂ is a weight factor for the feature loss, λ₃ is weight factor for the discrimination loss, λ₄ is weight factor for the landmark loss, and λ₅ is weight factor for the identity feature loss. In some examples, a weight factor or weight factors may be manually assigned. In some examples, a weight factor or weight factors may be determined automatically (by training a machine learning model to reduce the combined loss, for instance). For instance, an automatic approach to determine the weight factor may include using a machine learning model (e.g., automated machine learning (AutoML)) to perform a sweep of the hyper-parameters. In some examples, the weight factors may be assigned fixed values. In some examples, the values may be kept at a similar level during training. In some examples, the weight factors may be uniform (e.g., λ₁=1, λ₂=1, λ₃=1, λ₄=1, λ₅=1) or non-uniform. In some examples, the weight factors may depend on the loss function utilized to determine a corresponding loss.

In some examples, aspects of training the first machine learning model may be repeated and/or iterated. For example, the first machine learning model may be trained based on a training data set. For instance, the first machine learning model may be iteratively trained using a set of ground truth images and corresponding training images (e.g., degraded, down-sampled, and/or compressed training image from the ground truth images).

In some examples, the first machine learning model may be utilized to generate the enhanced object region after training. For instance, the first machine learning model may be trained by the apparatus or another device (e.g., remote device, computing device, server, etc.). In some examples where the first machine learning model is trained by another device, the trained first machine learning model may be provided (e.g., sent, transmitted, etc.) to the apparatus from the other device. For example, a remote device may transmit the trained first machine learning model and/or first machine learning model components (e.g., weight(s), gradient(s), node(s), layer(s), connection(s), etc.) to the apparatus. The apparatus may execute the first machine learning model to produce the enhanced object region.

The apparatus may generate 106, using a second machine learning model, an enhanced background region with a third resolution that is greater than the first resolution. In some examples, the third resolution may be equal to the second resolution in terms of pixel density. In some examples, the second resolution and/or the third resolution may be greater than the first resolution (in terms of pixel density, for instance) by an upscaling factor (e.g., 1.5, 2, 3, 3.25, 4, 5, etc.) relative to the first resolution. An example of the first resolution (e.g., low resolution) is 500×750 pixels (e.g., 125 pixels per inch (ppi)). Examples of a second resolution and/or third resolution (e.g., high resolution) may include 1000×1500 (×2 upscale), 1500×2250 (×3 upscale), and/or 2000×3000 (×4 upscale). In some examples, different models may be utilized for different upscale factors. While some examples of the first resolution, second resolution, and/or third resolution are given, different resolutions may be utilized in some examples. In some examples, a resolution of 750×1125 pixels or greater may be considered to be “high resolution” and lesser resolutions may be considered “low resolution.” In some examples, a resolution of 1000×1500 pixels or greater may be considered to be “high resolution” and lesser resolutions may be considered “low resolution.” Other threshold resolutions may be considered to divide low resolution from high resolution images in some examples.

In some examples, the second machine learning model may be a machine learning model that is trained to enhance background content (e.g., textures, buildings, scenery, mountains, plants, etc.). For instance, the second machine learning model may be trained to enhance general content and/or the first machine learning model may be trained to enhance a specific object or objects. In some examples, the second machine learning model may be trained without factors and/or values specific to object landmarks and/or object identity features. In some examples, the second machine learning model is trained or has been trained based on features from background region(s). In some examples, the second machine learning model may include a context-aware joint compression artifacts resolution (CAR) and super-resolution (SR) neural network and/or a deep reconstruction network. In some examples, the apparatus may provide the background region to the second machine learning model, which may produce the enhanced background region.

The apparatus may combine 108 the enhanced object region and the enhanced background region to produce an enhanced image. In some examples, the apparatus may join (e.g., merge) the enhanced object region(s) with the enhanced background region(s). For instance, the apparatus may place an enhanced object region in a location of the enhanced background region, where the location corresponds to a location from which the object region was segmented. In some examples, the apparatus may blend the enhanced object region(s) with the enhanced background region(s). For example, the apparatus may interpolate and/or filter pixel values along a boundary (e.g., within a range of the boundary) between the enhanced object region(s) and the enhanced background region(s).

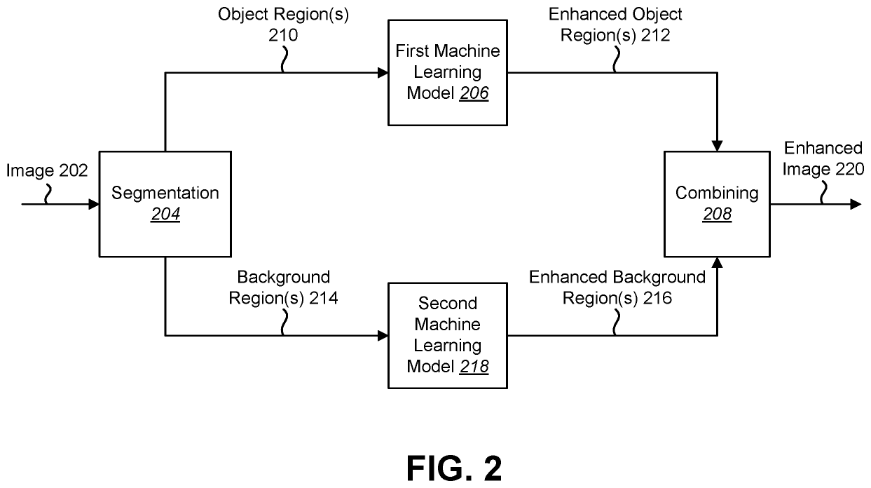

FIG. 2 is a block diagram illustrating examples of functions for image enhancement. In some examples, one, some, or all of the functions described in relation to FIG. 2 may be performed by the apparatus 324 described in relation to FIG. 3. For instance, instructions for segmentation 204, a first machine learning model 206, a second machine learning model 218, and/or combining 208 may be stored in memory and executed by a processor in some examples. In some examples, a function or functions (e.g., segmentation 204, the first machine learning model 206, the second machine learning model 218, and/or combining 208, etc.) may be performed by another apparatus. For instance, segmentation 204 may be carried out on a separate apparatus and sent to the apparatus.

An image 202 may be obtained. For example, the image 202 may be received from another device and/or may be generated. For instance, the apparatus may receive the image 202 from another device and/or may capture the image 202 using an image sensor (e.g., camera).

Segmentation 204 may be performed based on the image 202. For example, segmentation 204 may include segmenting the image 202 into an object region(s) 210 and a background region(s) 214 as described in relation to FIG. 1. In some examples, the object region(s) 210 may be provided to the first machine learning model 206 and the background region(s) 214 may be provided to the second machine learning model 218.

The first machine learning model 206 may determine (e.g., predict, infer, etc.) an enhanced object region(s) 212 based on the object region(s) 210. For example, the first machine learning model 206 may produce the enhanced object regions(s) 212 as described in relation to FIG. 1. The first machine learning model 206 may be trained based on object landmark(s) (e.g., landmark loss(es)), identity feature(s) (e.g., identity feature loss(es)), feature(s) (e.g., feature loss(es)), pixel loss(es), and/or classification(s) (e.g., discrimination loss(es)). The enhanced object region(s) 212 may be provided to the combining 208 function.

The second machine learning model 218 may determine (e.g., predict, infer, etc.) an enhanced background region(s) 216 based on the background region(s) 214. For example, the second machine learning model 218 may produce the enhanced object regions(s) 212 as described in relation to FIG. 1. The enhanced background region(s) 216 may be provided to the combining 208 function.

The combining 208 function may combine the enhanced object region(s) 212 and the enhanced background region(s) 216 to produce an enhanced image. For example, the combining 208 function may produce the enhanced image 220 as described in relation to FIG. 1.

Some examples of the techniques described herein may be utilized to perform resolution enhancement for images including faces. In some examples, the second machine learning model 218 may be a more general model used to reconstruct the background (e.g., non-face region(s)), and the first machine learning model 206 may be a face-specific model for the face region(s). For instance, multiple machine learning models may be utilized instead of using one machine learning model to process the whole image. In some examples, the first machine learning model 206 may reconstruct images with an upscale factor (e.g., ×2, ×3, ×4, etc.). For instance, the first machine learning model may be trained based on real-world photos (e.g., selfie and/or group photos) taken from different devices under various conditions, where the face regions may differ in size. The first machine learning model 206 may reconstruct face regions of a range of input sizes and/or may be robust against image noise in some examples.

In some examples, face priors may be utilized. For instance, the first machine learning model 206 may be trained and/or re-trained based on weights of a general model. In some examples, a prior or priors may be utilized to enhance realism in the enhanced object region(s) 212 and/or the enhanced image 220: GAN (e.g., original versus generated image), texture features, facial landmark points, and/or face identity. In some examples, a pretrained network or networks from other computer vision tasks (e.g., recognition) may be utilized to extract the priors from an image. In some examples, the first machine learning model 206 may accordingly be trained based on a variety of image datasets and/or may not demand manual annotations for training.

In some examples for enhanced face rendering, the examples of FIG. 2 may perform a function or functions as follows. For instance, segmentation 204 may operate as a face detector to detect a face region or regions from the image 202. According to the detection, the image 202 may be split into a face region or regions and a non-face region or regions (e.g., background). The face region(s) may be provided to the first machine learning model 206 (e.g., a face-specific machine learning model) and the non-face region(s) may be provided to the second machine learning model 218 (e.g., a machine learning model to enhance general content). The results of the two machine learning model models may be combined and/or blended by the combining 208 function to produce the enhanced image 220. Blending may be performed in some examples, which may help to reduce visible differences between the images generated by the two models.

FIG. 3 is a block diagram of an example of an apparatus 324 that may be used in image enhancement. The apparatus 324 may be a computing device, such as a personal computer, a server computer, a printer, a 3D printer, a smartphone, a tablet computer, etc. The apparatus 324 may include and/or may be coupled to a processor 328, a communication interface 330, a memory 326, and/or an image sensor or sensors 332. In some examples, the apparatus 324 may be in communication with (e.g., coupled to, have a communication link with) another device (e.g., server, remote device, another apparatus, etc.). The apparatus 324 may include additional components (not shown) and/or some of the components described herein may be removed and/or modified without departing from the scope of the disclosure.

The processor 328 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 326. The processor 328 may fetch, decode, and/or execute instructions stored on the memory 326. In some examples, the processor 328 may include an electronic circuit or circuits that include electronic components for performing a functionality or functionalities of the instructions. In some examples, the processor 328 may perform one, some, or all of the aspects, elements, techniques, etc., described in relation to one, some, or all of FIGS. 1-5.

The memory 326 is an electronic, magnetic, optical, and/or other physical storage device that contains or stores electronic information (e.g., instructions and/or data). The memory 326 may be, for example, Random Access Memory (RAM), Electrically Erasable Programmable Read-Only Memory (EEPROM), a storage device, an optical disc, and/or the like. In some examples, the memory 326 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some examples, the memory 326 may be a non-transitory tangible machine-readable storage medium, where the term “non-transitory” does not encompass transitory propagating signals. In some examples, the memory 326 may include multiple devices (e.g., a RAM card and a solid-state drive (SSD)).

The apparatus 324 may include a communication interface 330 through which the processor 328 may communicate with an external device or devices (not shown), for instance, to receive and store image data 336. The communication interface 330 may include hardware and/or machine-readable instructions to enable the processor 328 to communicate with the external device or devices. The communication interface 330 may enable a wired or wireless connection to the external device or devices. The communication interface 330 may further include a network interface card and/or may also include hardware and/or machine-readable instructions to enable the processor 328 to communicate with various input and/or output devices, such as a keyboard, a mouse, a display, another apparatus, electronic device, computing device, printer, etc. In some examples, an input device may be utilized by a user to input instructions into the apparatus 324.

In some examples, the memory 326 may store image data 336. The image data 336 may be obtained (e.g., captured, received, etc.) from an image sensor(s) 332 and/or may be generated (e.g., determined, predicted, inferred, and/or enhanced). For example, the processor 328 may execute instructions (not shown in FIG. 3) to obtain (e.g., receive) an image or images. For instance, the apparatus 324 may receive a text message with an embedded image, may download an image from a website and/or platform (e.g., social media platform, web page, etc.), and/or may receive a notification with an image. The image(s) may be stored as image data 336 in the memory 326. In some examples, the apparatus 324 may include an image sensor(s) 332, may be coupled to a remote image sensor(s), and/or may receive image data 336 (e.g., an image or images) from an (integrated and/or remote) image sensor. In some examples, the image or images may be (and/or may include) a face image or images. A face image is an image that depicts a face (e.g., a human face).

The memory 326 may store enhancement instructions 341. For example, the enhancement instructions 341 may be instructions for enhancing an image or images. Enhancing the image(s) may include increasing the resolution of the image(s) and/or reducing an artifact(s) in the image(s). In some examples, the enhancement instructions 341 may include data defining and/or implementing a machine learning model or models. In some examples, the machine learning model(s) may include a neural network or neural networks. For instance, the enhancement instructions 341 may define a node or nodes, a connection or connections between nodes, a network layer or network layers, and/or a neural network or neural networks.

In some examples, the enhancement instructions 341 may include a machine learning model or models. For instance, the enhancement instructions 341 may include a first machine learning model and/or a second machine learning model. The first machine learning model described in relation to FIG. 3 may be an example of the first machine learning model(s) described in relation to FIG. 1 and/or FIG. 2. For instance, the first machine learning model may be trained based on a landmark loss and an identity feature loss. The second machine learning model described in relation to FIG. 3 may be an example of the second machine learning model(s) described in relation to FIG. 1 and/or FIG. 2.

In some examples, the processor 328 may utilize a first machine learning model to produce an enhanced face image based on a face image. For instance, the first machine learning model may be executed to determine (e.g., predict, infer, etc.) the enhanced face image as described in relation to FIG. 1 and/or FIG. 2. The enhanced face image may have a second resolution that is greater than a first resolution of the face image. In some examples, the enhanced face image may be stored in enhanced image data 338 in the memory 326.

In some examples, the memory 326 may store segmentation instructions 334. The segmentation instructions 334 may be instructions for detecting an object region or regions and/or segmenting images. For instance, the processor 328 may execute the segmentation instructions 334 to detect a face in an image. In some examples, detecting a face in an image may be performed as described in relation to FIG. 1 and/or FIG. 2. The processor 328 may execute the segmentation instructions 334 to segment the image to produce the face image and a background image. In some examples, segmenting an image may be performed as described in relation to FIG. 1 and/or FIG. 2. The face image may be provided to the first machine learning model to produce an enhanced face image as described herein.

In some examples, the processor 328 may execute the enhancement instructions to execute a second machine learning model to produce an enhanced background image. In some examples, executing the second machine learning model to produce the enhanced background image may be performed as described in relation to FIG. 1 and/or FIG. 2. The enhanced background image may be stored in the enhanced image data 338. In some examples, the processor 328 may execute the enhancement instructions 341 to combine the enhanced face image and the enhanced background image to produce an enhanced image, which may be stored in the enhanced image data 338.

In some examples, the memory 326 may store training instructions 342 and/or training data 344. The processor 328 may execute the training instructions 342 to train the machine learning model(s) using the training data 344. Training data 344 is data to train the machine learning model(s). Examples of training data 344 may include ground truth images and degraded images (e.g., down-sampled and/or compressed images). For example, the training data 344 may include low-resolution degraded images (with a resolution of 500×750 pixels or other resolution, for instance). In some examples, the training data 344 may include high-resolution ground truth data (with a resolution of 1000×1500, 1500×2250, 2000×3000, or other resolution, for instance). In some examples, training image pairs may be generated from an original image with some degradation (e.g., downsampling, compression, etc.), training image pairs may be separately rendered from a graphic engine, and/or training image pairs may be acquired using physical approaches (e.g., zoom lenses).

In some examples, the processor 328 may execute the training instructions using the degraded images and the corresponding ground truth images. Using the degraded images and the ground truth images, for instance, the processor 328 may execute the training instructions to train the first machine learning model to produce an enhanced object image (e.g., enhanced face images) from a degraded object image (e.g., degraded face image).

In some examples, the training instructions 342 may include a landmark detection machine learning model (e.g., pretrained landmark detection machine learning model), an identity feature extraction machine learning model (e.g., pretrained identity feature extraction machine learning model), a feature extraction machine learning model (e.g., a pretrained feature extraction machine learning model) and/or a discrimination machine learning model. In some examples, the discrimination machine learning model is not pretrained and/or may be jointly trained with the first machine learning model.

In some examples, the processor 328 may execute the training instructions 342 to determine a loss or losses. For instance, the processor 328 may provide a ground truth image (e.g., ground truth face image) and a corresponding degraded image (e.g., degraded face image) to a machine learning model or models to determine a landmark loss (based on landmarks detected by the landmark detection machine learning model, for instance), an identity feature loss (based on identity features extracted by the identity feature extraction machine learning model), a feature loss (based on features extracted by the feature extraction machine learning model), and/or a discrimination loss (based on classifications determined by the discrimination machine learning model). In some examples, the processor 328 may execute the training instructions 342 to produce a pixel loss. Determining the loss or losses may be performed as described in relation to FIG. 1 and/or FIG. 2 in some examples.

In some examples, the processor 328 may execute the training instructions 342 to train the first machine learning model based on a landmark loss, an identity feature loss, a pixel loss, a feature loss, and/or a discrimination loss. In some examples, training the first machine learning model may be performed as described in relation to FIG. 1. For instance, the processor 328 may adjust a weight or weights of the first machine learning model based on the landmark loss, the identity feature loss, the pixel loss, the feature loss, and/or the discrimination loss.

In some examples, not all of the operations and/or features described in relation to FIG. 3 may be utilized and/or implemented. For instance, the apparatus 324 may receive a first machine learning model that has been trained by another device and may utilize the first machine learning model to produce an enhanced image. For instance, the apparatus 324 may not train the first machine learning model in some examples. In some examples, the apparatus 324 may train and/or may send the first machine learning model to another device.

The memory 326 may store operation instructions 346. In some examples, the processor 328 may execute the operation instructions 346 to perform an operation based on the enhanced image(s). In some examples, the processor 328 may execute the operation instructions 346 to send (e.g., serve) the enhanced image(s) to another device. In some examples, the processor 328 may print the enhanced image(s). In some examples, the processor 328 may present the enhanced image(s) (e.g., provide and/or send the enhanced image(s) to a display for presentation). In some examples, the processor 328 may replace and/or overlay an image or images (e.g., source images) with the enhanced image(s). For instance, the processor 328 may replace source images from a website or platform with the corresponding enhanced image(s) (e.g., display the enhanced image(s) instead of or in addition to the source image(s) in a browser or application).

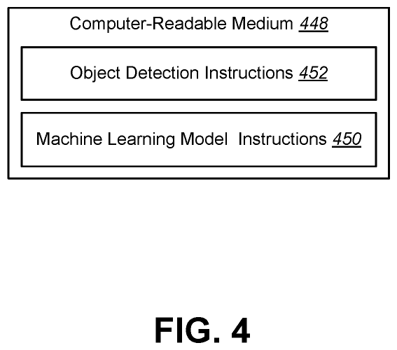

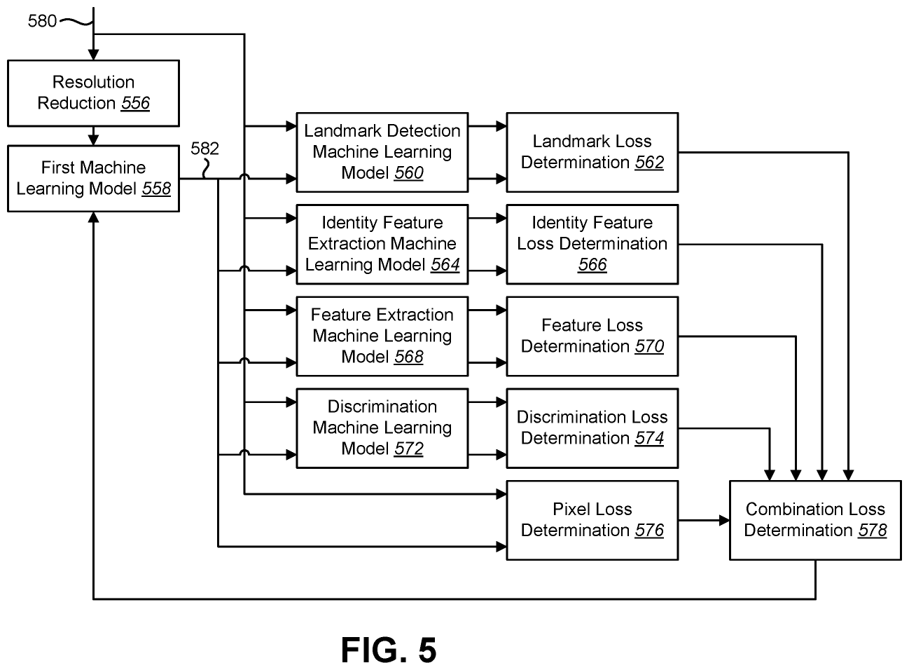

FIG. 4 is a block diagram illustrating an example of a computer-readable medium 448 for image enhancement. The computer-readable medium 448 is a non-transitory, tangible computer-readable medium. The computer-readable medium 448 may be, for example, RAM, EEPROM, a storage device, an optical disc, and the like. In some examples, the computer-readable medium 448 may be volatile and/or non-volatile memory, such as DRAM, EEPROM, MRAM, PCRAM, memristor, flash memory, and the like. In some examples, the memory 326 described in relation to FIG. 3 may be an example of the computer-readable medium 448 described in relation to FIG. 4. In some examples, the computer-readable medium may include code, instructions and/or data to cause a processor perform one, some, or all of the operations, aspects, elements, etc., described in relation to one, some, or all of FIG. 1, FIG. 2, FIG. 3, FIG. 4, and/or FIG. 5.

The computer-readable medium 448 may include code (e.g., data, executable code, and/or executable instructions). For example, the computer-readable medium 448 may include machine learning model instructions 450 and/or object detection instructions 452.

The object detection instructions 452 may include code to cause a processor to detect an object region in an image. In some examples, detecting the object region in an image may be performed as described in relation to FIG. 1, FIG. 2, and/or FIG. 3. In some examples, the object region includes detected text. For instance, the processor may execute the object detection instructions 452 to detect an object region or regions that include text in an image.

The machine learning model instructions 450 may include code to cause a processor to use a machine learning model to increase a resolution of the object region to produce an enhanced object region. The machine learning model may be an example of the first machine learning model(s) described in relation to FIG. 1, FIG. 2, FIG. 3, and/or FIG. 4. In some examples, using a machine learning model to increase the resolution of the object region may be performed as described in relation to FIG. 1, FIG. 2, and/or FIG. 3. In some examples, the machine learning model may be trained based on object identity features. In some examples, the machine learning model may be trained based on object landmark features. In some examples, the computer-readable medium 448 may include instructions to perform an operation or operations described in relation to FIG. 1, FIG. 2, FIG. 3, FIG. 4, and/or FIG. 5.

FIG. 5 is a block diagram illustrating an example of first machine learning model 558 training. The functions, operations, and/or elements described in relation to FIG. 5 may be realized in hardware (e.g., circuitry) or a combination of hardware and instructions (e.g., a processor with instructions).

A ground truth image 580 (e.g., image region, face region, object region, etc.) may be provided to resolution reduction 556, a landmark detection machine learning model 560, an identity feature extraction machine learning model 564, a feature extraction machine learning model 568, a discrimination machine learning model 572, and/or a pixel loss determination 576 function. The resolution reduction 556 function may reduce the resolution of the ground truth image 580 to produce a training image. For example, the ground truth image 580 may be degraded, down-sampled, compressed, etc., to produce the training image. The training image may be provided to the first machine learning model 558.

The first machine learning model 558 may be an example of the first machine learning model(s) described in relation to FIG. 1, FIG. 2, FIG. 3, and/or FIG. 4. The first machine learning model 558 may produce an enhanced training image 582 based on the training image. The enhanced training image may be provided to the landmark detection machine learning model 560, identity feature extraction machine learning model 564, feature extraction machine learning model 568, discrimination machine learning model 572, and/or pixel loss determination 576 function. The landmark detection machine learning model 560, identity feature extraction machine learning model 564, feature extraction machine learning model 568, discrimination machine learning model 572, and/or pixel loss determination 576 function may be examples of corresponding elements described in relation to FIG. 1, FIG. 2, FIG. 3, and/or FIG. 4.

The landmark detection machine learning model 560 may determine object landmarks based on the enhanced training image 582. The landmark detection machine learning model 560 may determine second landmarks based on the ground truth image 580. In some examples, the landmark detection machine learning model 560 may be executed to determine the object landmarks based on the enhanced training image 582 and may be separately executed to determine the second landmarks based on the ground truth image 580. The object landmarks and the second landmarks may be provided to a landmark loss determination 562 function. In some examples, a machine learning model or models (e.g., the landmark detection machine learning model 560, the identity feature extraction machine learning model 564, the feature extraction machine learning model 568, and/or the discrimination machine learning model 572) may include separate instances of the respective machine learning model(s) that are respectively executed on the ground truth image 580 and on the enhanced training image 582. For instance, the landmark detection machine learning model 560 may include a first instance that is executed on the enhanced training image 582 to produce object landmarks and a second instance that is executed on the ground truth image 380 to produce the second landmarks.

The landmark loss determination 562 function may determine a landmark loss based on the object landmarks and the second landmarks. For example, the landmark loss may be determined as described herein. The landmark loss may be provided to a combination loss determination 578 function.

The identity feature extraction machine learning model 564 may determine first identity features based on the enhanced training image 582. The identity feature extraction machine learning model 564 may determine second identity features based on the ground truth image 580. In some examples, the identity feature extraction machine learning model 564 may be executed to determine the first identity features based on the enhanced training image 582 and may be separately executed to determine the second identity features based on the ground truth image 580. The first identity features and the second identity features may be provided to an identity feature loss determination 566 function.

The identity feature loss determination 566 function may determine an identity feature loss based on the first identity features and the second identity features. For example, the identity feature loss may be determined as described herein. The identity feature loss may be provided to the combination loss determination 578 function.

The feature extraction machine learning model 568 may determine first features based on the enhanced training image 582. The feature extraction machine learning model 568 may determine second features based on the ground truth image 580. In some examples, the feature extraction machine learning model 568 may be executed to determine the first features based on the enhanced training image 582 and may be separately executed to determine the second features based on the ground truth image 580. The first features and the second features may be provided to a feature loss determination 570 function.

The feature loss determination 570 function may determine a feature loss based on the first features and the second features. For example, the feature loss may be determined as described herein. The feature loss may be provided to the combination loss determination 578 function.

The discrimination machine learning model 572 may determine a first classification based on the enhanced training image 582. The discrimination machine learning model 572 may determine a second classification based on the ground truth image 580. In some examples, the discrimination machine learning model 572 may be executed to determine the first classification based on the enhanced training image 582 and may be separately executed to determine the second classification based on the ground truth image 580. The first classification and the second classification may be provided to a discrimination loss determination 574 function.

The discrimination loss determination 574 function may determine a discrimination loss based on the first classification and the second classification. For example, the discrimination loss may be determined as described herein. The discrimination loss may be provided to the combination loss determination 578 function.

The pixel loss determination 576 function may determine a pixel loss based on the ground truth image 580 and the enhanced training image 582. For example, the pixel loss may be determined as described herein. The pixel loss may be provided to the combination loss determination 578 function.

The combination loss determination 578 function may determine a combination loss (e.g., total loss) based on the landmark loss, the identity feature loss, the feature loss, the discrimination loss, and/or the pixel loss. The combination loss may be provided to the first machine learning model 558 to train the first machine learning model 558.

In some examples, the first machine learning model 558 may be a face-specific reconstruction model (e.g., neural network). For instance, the first machine learning model 558 may receive a face region from an input image and generate an output with enhanced resolution and/or quality. The first machine learning model 558 may be trained using another model or models (e.g., the landmark detection machine learning model 560, the identity feature extraction machine learning model 564, the feature extraction machine learning model 568, and/or the discrimination machine learning model 572). For instance, the enhanced training image 582, the ground truth image 580, and/or corresponding meta information (e.g., face identity, facial landmarks) may be used during training. For example, the meta information may be utilized to calculate the losses described herein. In some examples, during training of the first machine learning model 558, two types of data flows may be utilized: the forward flow of generated data (e.g., the enhanced training image(s) 582), and a ground truth data flow (e.g., the ground truth image(s) 580) to compute corresponding features in loss terms as described herein. A combined loss may include the losses as described herein.

Some examples of the techniques described herein may include a workflow to combine general image enhancement with object-specific (e.g., face-specific) enhancement to generate enhanced visual results for real-world images. For instance, a workflow may include a face-specific model that utilizes GAN, texture features, facial landmarks, and/or face identity features with pixel values in training. Some examples of the techniques described herein may generate an enhanced object (e.g., face) result while producing reliable and/or stable results with high fidelity background (e.g., non-face) regions. For instance, some examples of the techniques may provide enhanced facial details (e.g., eye lashes, beard, etc., with enhanced detail) in enhanced-resolution images.

While various examples are described herein, the disclosure is not limited to the examples. Variations of the examples described herein may be implemented within the scope of the disclosure. For example, aspects or elements of the examples described herein may be omitted or combined.

1. A method, comprising:
segmenting an image into an object region and a background region, wherein the image has a first resolution;
generating, using a first machine learning model, an enhanced object region with a second resolution that is greater than the first resolution, wherein the first machine learning model has been trained based on object landmarks;
generating, using a second machine learning model, an enhanced background region with a third resolution that is greater than the first resolution; and
combining the enhanced object region and the enhanced background region to produce an enhanced image.

2. The method of claim 1, wherein the first machine learning model is trained based on:
determining, using the first machine learning model, an enhanced training image based on a training image;
determining, using a landmark detection machine learning model, the object landmarks based on the enhanced training image;
determining, using the landmark detection machine learning model, second landmarks based on a ground truth image; and
determining a landmark loss based on the object landmarks and the second landmarks.

3. The method of claim 2, wherein the first machine learning model is trained based on adjusting weights of the first machine learning model using the landmark loss.

4. The method of claim 1, wherein the first machine learning model is trained based on:
determining, using the first machine learning model, an enhanced training image based on a training image;
determining, using an identity feature extraction machine learning model, first identity features based on the enhanced training image;
determining, using the identity feature extraction machine learning model, second identity features based on a ground truth image; and
determining an identity feature loss based on the first identity features and the second identity features.

5. The method of claim 4, wherein the first machine learning model is trained based on adjusting weights of the first machine learning model based on the identity feature loss.

6. The method of claim 1, wherein the first machine learning model is trained based on:
determining, using the first machine learning model, an enhanced training image based on a training image;
determining, using a feature extraction machine learning model, first features based on the enhanced training image;
determining, using the feature extraction machine learning model, second features based on a ground truth image; and
determining a feature loss based on the first features and the second features.

7. The method of claim 1, wherein the first machine learning model is trained based on:
determining, using the first machine learning model, an enhanced training image based on a training image;
classifying, using a discrimination machine learning model, the enhanced training image to produce a first classification;
classifying, using the discrimination machine learning model, a ground truth image to produce a second classification; and
determining a discrimination loss based on the first classification and the second classification.

8. The method of claim 1, wherein the first machine learning model is trained based on:
determining, using the first machine learning model, an enhanced training image based on a training image; and
determining a pixel loss between the enhanced training image and a ground truth image.

9. The method of claim 1, wherein the first machine learning model is trained based on:
determining a combined loss based on a pixel loss, a feature loss, a discrimination loss, a landmark loss, and an identity feature loss; and
adjusting weights of the first machine learning model based on the combined loss.

10. An apparatus, comprising:
a memory; and
a processor coupled to the memory, wherein the processor is to:
execute a first machine learning model to produce an enhanced face image based on a face image, wherein the first machine learning model is trained based on a landmark loss and an identity feature loss, and wherein the enhanced face image has a second resolution that is greater than a first resolution of the face image.

11. The apparatus of claim 10, wherein the processor is to:
detect a face in an image;
segment the image to produce the face image and a background image; and
execute a second machine learning model to produce an enhanced background image.

12. The apparatus of claim 10, wherein the first machine learning model is trained further based on a pixel loss, a feature loss, and a discrimination loss.

13. A non-transitory tangible computer-readable medium storing executable code, comprising:
code to cause a processor to detect an object region in an image; and
code to cause the processor to use a machine learning model to increase a resolution of the object region to produce an enhanced object region, wherein the machine learning model is trained based on object identity features.

14. The computer-readable medium of claim 13, wherein the object region includes detected text.

15. The computer-readable medium of claim 13, wherein the machine learning model is trained based on object landmark features.
